(19) United States
(12) Patent Application Publication
(10) Pub. No.: US 2019/0124180 A1
(43) Pub. Date: Apr. 25, 2019

(54) PACKET COMPRESSION AND DECOMPRESSION

(71) Applicant: Hewlett Packard Enterprise Development LP, Houston, TX (US)

(72) Inventors: Frank Dropps, Eagan, MN (US); Russell Nicol, Chippewa Falls, WI (US); Kirill Malkin, Parsippany, NJ (US)

(21) Appl. No.: 15/789,394

(22) Filed: Oct. 20, 2017

(51) Int. Cl. H04L 29/06

(52) U.S. Cl. CPC H04L 69/04; H04L 69/22

(57) ABSTRACT

A transmitting device can compress a packet prior to transmitting the packet to a receiving device, which then decompresses the packet. The packet can be combined into a single combined packet with other packets within a transmission queue of the same type and that refer to consecutive memory block addresses. A header of the packet can be replaced with a reduced-size header including a sequence number and a flag indicating the header has been replaced with the reduced-size header, if the packet has a consecutive memory block address to that of the most recently transmitted packet. A payload of the packet may also be compressed.

### BACKGROUND

Different types of devices that communicate with one another include computing devices, memory, networking devices like network switches and network adapters, node controllers, as well as other types of devices. A computing device may include one or more processors, which can also be considered devices that can communicate with one another. Processors that communicate with one another may be part of the same computing device, or different devices. Furthermore, a processor may include multiple processor cores, which also can communicate with one another.

### BRIEF DESCRIPTION OF THE DRAWINGS

FIGS. 1, 2, and 3 are diagrams illustratively depicting different example packet compression techniques.

FIG. 4 is a flowchart of a method for compressing a packet using the packet compression techniques of FIGS. 1, 2 and 3, and then transmitting the compressed packet.

FIG. 5 is a flowchart of a method for receiving a packet compressed via the method of FIG. 4, and then decompressing and processing the packet.

FIG. 6 is a diagram of a system including a transmitting device and a receiving device.

### DETAILED DESCRIPTION

As noted in the background, one type of type of device is a computing device that can include multiple processors, including multiple processing cores. Processors execute program code, such as processing threads. The threads may be related to one another, and as such, may have to exchange data with each other. For example, a processor executing one thread may request data from a processor executing another thread. The former processor sends a packet of a request packet type to the latter processor, which responds with a packet of a data packet type that includes the requested data.

To increase processing speeds, the rate and bandwidth at which communication can occur may be increased, and the latency with which packets are communicated may be decreased. Such rate and bandwidth increases and latency decreases can be achieved by increasing the number of interface lanes that interconnect the processors. However, adding interface lanes can increase logic die size, the number of semiconductor package pins, and the number of cable connectors, all of which can increase manufacturing cost. Rate and bandwidth increase and latency decrease may also be achieved by increasing communication baud rate, but semiconductor fabrication process and circuit design technology can limit how much baud rate can be increased.

By comparison, techniques described herein provide for increased rate and bandwidth and decreased latency of communication without adding interface lanes or increasing baud rate. Rather, the packets sent between devices are compressed in a variety of different ways. A transmitting device can thus compress a packet before transmitting the packet to a receiving device, which upon receipt of the packet decompresses the packet prior to processing it. The techniques describe herein can be applied to other types of devices that communicate with one another, besides processors and processor cores.

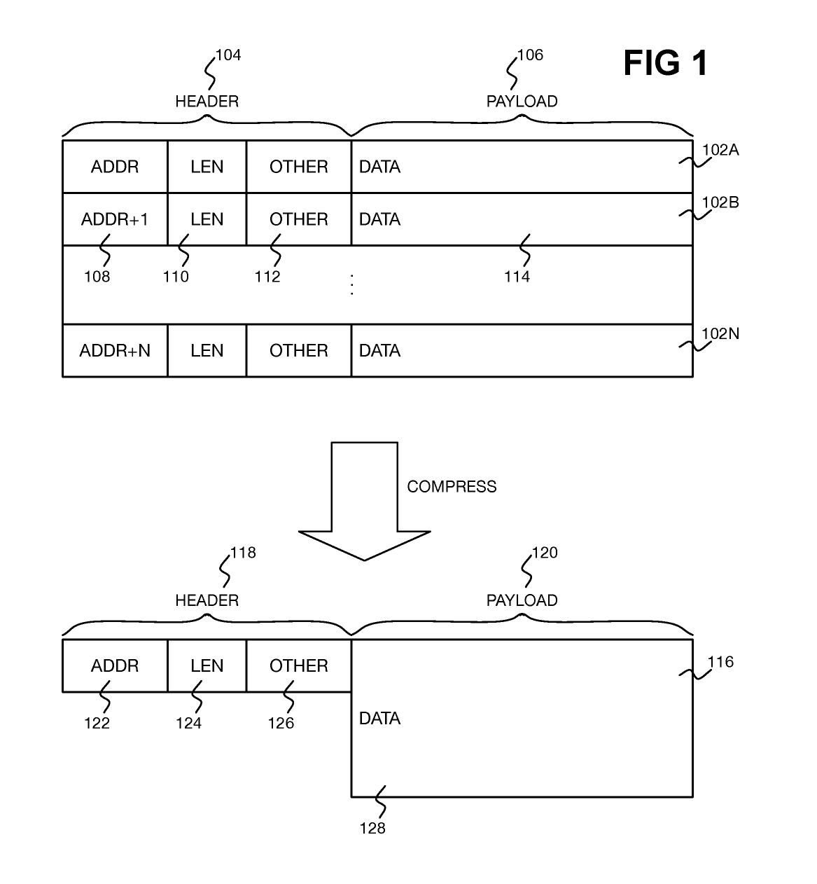

FIG. 1 illustratively depicts a first example packet compression technique. Multiple packets 102A, 102B, . . . 102N, collectively referred to as the packets 102, may be queued for transmission within a transmission queue of a transmitting device. There are at least two packets 102. Each packet 102 includes a header 104. As depicted in FIG. 1, each packet 102 also includes a payload 106. The packets 102 may each include a payload 106 when the packets are of a data packet type, in which data is transmitted by the transmitting device to a receiving device. By comparison, packets of a request packet type, in which the transmitting device requests that the receiving device send data, may not include payloads.

The header 104 of each packet 102 includes a memory block address 108, a length 110, and other information 112. The memory block address 108 specifies the memory address to which the packet 102 pertains. The length 110 specifies the length, such as in bytes, of the packet 102 as a whole, including the header 104 and, if present, the payload 106. The length 110 of a packet 102 may be explicitly encoded, or in another implementation, may be implied or implicit because each packet 108 has a same fixed length. The other information 112 can include the type of the packet (e.g., a data packet type, a request packet type, and so on), error-detection codes, and so on. The packets 102 are of the same type, and can each have the same length 110. The payload 106 of each packet 102, when present, includes the data 114 that the packet 102 of the data packet type is conveying.

The memory block addresses 108 of the packets 102 are consecutive to one another in the example of FIG. 1. This is indicated by the packet 102A having ADDR as its address 108, the packet 102B having ADDR+1 as its address 108, and the packet 102N having the ADDR+N as its address 108. For example, if each packet 102 refers to a 64-bit word of data, then the packet 1026 has an address that is 64 bits past the address of the packet 102A, the next packet 102 adjacent to the packet 102C has an address that is 128 bits past the address of the packet 102A, and so on.

The packets 102 are combined into a single combined packet 116 in the example compression technique of FIG. 1. The combined packet 116 also has a header 118 and can have a payload 120. The size of the header 118 of the combined packet 116 may be equal to the size of the header 104 of each packet 102. The header 118 includes a block address 122, which is equal to the address 108 of the packet 102A. The header 118 includes a length 124, which is the length, such as in bytes, of the combined packet 116. The length 124 of the combined packet 116 may be equal to the length 110 of each packet 102 if the packets 102 and thus the packet 116 are of the request packet type, and may be greater than the length 110 of each packet 102 if the packets 102 and the packet 116 are of the data packet type.

The header 118 includes other information, such as the type of the packet 116, which is same as the type of each packet 102, as well as other information. If the packets 102 and thus the packet 116 are of the data packet type, then the payload 120 is present. The payload 120 includes the data 1114 of each data packet 102, concatenated in order from the packet 102A through the packet 102N.

The single combined packet 116 has a smaller size than the total size of the packets 102. Specifically, the reduction in size of the packet 116 can be equal to the size of the header 104 of a packet 102, multiplied by a value of the total number of packets 102 minus one. That is, whereas the packets 102 as a whole include N headers 104, the combined packet 116 includes one header 118, for a reduction of size that may be equal to (N−1) headers.

If the single combined packet 116 does not include a payload 120 (that is, the packets 102 do not include payloads 106), then the length 124 of the combined packet 116 can be equal to the length 110 of a packet 102. If the combined packet 116 does include a payload 120, then the length 124 can be equal to the size of a header 104, plus the sum of the payloads 106 of the packets 102. The combined packet 116, in other words, can still include the payload 106 of each packet 102.

When the receiving device receives the single combined packet 116, the receiving device may decompose the combined packet 116 back into the packets 102, or into a number of packets other than the N packets 102, before processing. The receiving device may just be able to process packets of a maximum length. Therefore, if the length 124 of the packet 116 is too large, the receiving device can divide the packet 116 into a number of smaller packets, by performing the reverse of the process that has been described to combine the packets 102 into the combined packet 116.

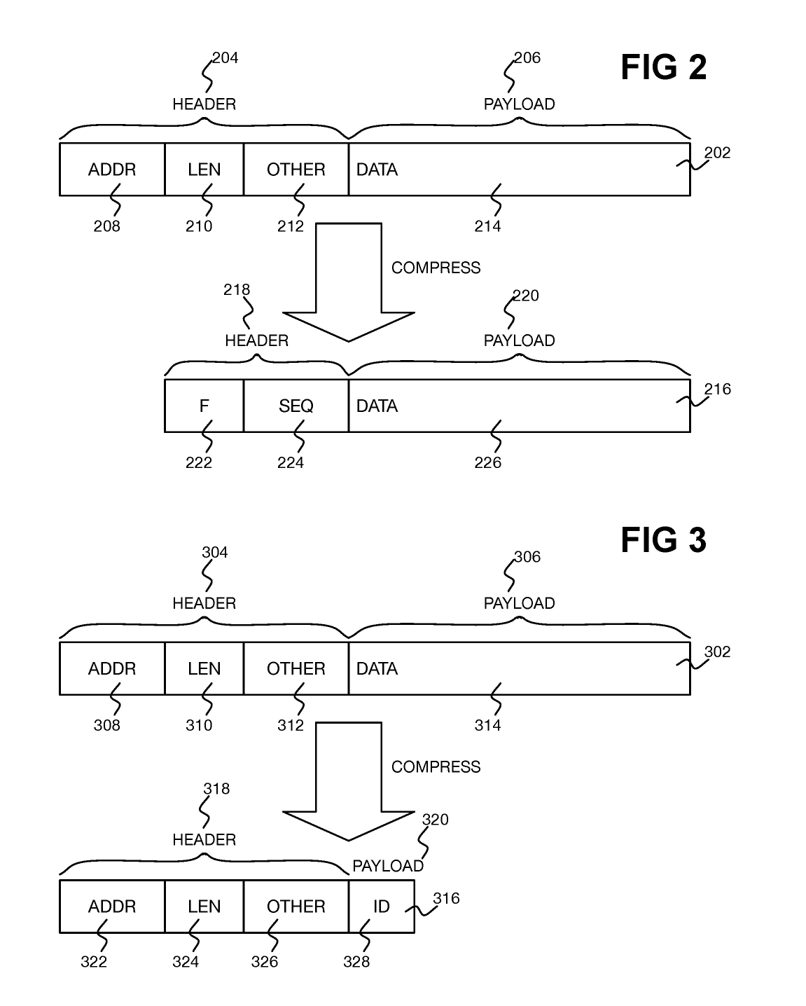

FIG. 2 illustratively depicts a second example packet compression technique. A packet 202 is to be transmitted by a transmitting device to a receiving device. The packet 202 includes a header 204, and can also include a payload 206, as in the example of FIG. 1. Also as in FIG. 1, the header 204 of the packet 202 includes a memory block address 208, a length 210, and other information 212. The payload 206, when present, includes the data 214 that the packet 202 of the data packet type is conveying.

In the example of FIG. 2, it is presumed that the transmitting device most recently transmitted a packet to the receiving device of the same packet type as the packet 202, and that the address 208 of the packet 202 is consecutive to the address of this most recently transmitted packet. In the corresponding example compression technique, then, the packet 202 is compressed into the packet 216. Specifically, the header 204 of the packet 202 is replaced with a reduced-size header 218 in the packet 216. By comparison, the packet 216's payload 220 and the data 226 thereof may be identical the packet 202′s payload 206 and the data 214 thereof.

Rather than including a block address 208, a length 210, and other information 212 like the header 204 does, the header 218 includes a flag 222 and a sequence number 224. The flag 222 is a unique series of bits that denotes that the header 218 is not a regular or standard header, such as the header 204 of the packet 202, but rather is a reduced-sized header that, besides the flag 222, may include just the sequence number 224. The sequence number 224 may be equal to the number of packets with reduced-size headers that have been consecutively sent from the transmitting device to the receiving device with consecutive memory block addresses, where the first such packet has a memory block address consecutive to a preceding packet with a regular, standard, or full-sized header.

For example, if the packet sent prior to the packet 202 was of the same type as the packet 202 and had a full-sized header, then the sequence number 224 may be one, indicating that the packet 216 is the first packet transmitted in the sequence with a header of reduced size. If the packet sent within a prescribed number of other packets after the packet 216 (i.e., the compressed version of the packet 202) is of the same type as the packet 216, then the sequence number of that packet may be two, and so on. Therefore, if N packets of the same type and that refer to consecutive block addresses are sent from the transmitting device to the receiving device, the first packet includes a full-sized header, and the remaining N−1 packets include reduced-size headers that have sequence numbers 1, 2, . . . , N−1.

The header 218 has a smaller size than the header 204 because the size of the address 208, the length 210, and the other information 212 in total is less than the size of the flag 222 and the sequence number 224. Packets sent from the transmitting device to the receiving device that have such reduced-size headers can have the same length as the most recent packet that the transmitting device sent to the receiving device that had a full-sized header. Similarly, such packets with reduced-size headers are of the same type as the most recent packet sent by the transmitting device to the receiving device that had a full-sized header. As such, the receiving device can expand the header 218 of the received packet 216 back into the header 204 to regenerate the packet 202 prior to processing.

FIG. 3 illustratively depicts a third example packet compression technique, which is applicable for packets of a data packet type or other packet type such that the packets include payloads and not just headers. A packet 302 is to be transmitted by a transmitting device to a receiving device. The packet 302 includes a header 304 and a payload 306, as in the example of FIGS. 1 and 2. Also as in FIGS. 1 and 2, the header 304 includes a memory block address 308, a length 310, and other information 312. The payload 306 includes the data 314 that the packet 302 is conveying.

In the example compression technique of FIG. 3, the packet 302 is compressed into the packet 316. The header 318 of the packet 302 can include a memory block address 322 that is identical to the address 308 of the header 304, and other information 326 that is identical to the other information 312 of the header 304. The length 324 that the header 318 specifies, however, can be shorter than the length 310 that header 304 specifies, since the packet 316 is smaller in size than the packet 302.

The packet 316 is a compressed version of the packet 302 insofar as the data 314 of the payload 306 has been replaced by an identifier 328 within the payload 320. For example, the transmitting device may refer to a compression dictionary that maps data patterns to unique identifiers. The transmitting device looks up the pattern of the data 314—i.e., the unique sequence of bits of the data 314—within the dictionary to determine the unique identifier that corresponds to this pattern. The unique identifier can be much smaller in size than the data 314 itself. The transmitting device compresses the packet 302 into the packet 316, therefore, by substituting this unique identifier 328 within the payload 320 for the data 314 of the payload 306.

The receiving device has a version of the same compression dictionary. Rather than mapping data patterns to unique identifiers, however, the receiving device's dictionary maps unique identifiers to data patterns. Therefore, when the receiving device receives the compressed packet 316 from the transmitting device, the receiving device looks up the unique identifier 328 of the payload 320 within its dictionary, and replaces the identifier 328 with the data 314 to generate the decompressed packet 302. The receiving device can also calculate the length 310 of the packet 302 and replace the compressed packet 316's length 324 with this length 310.

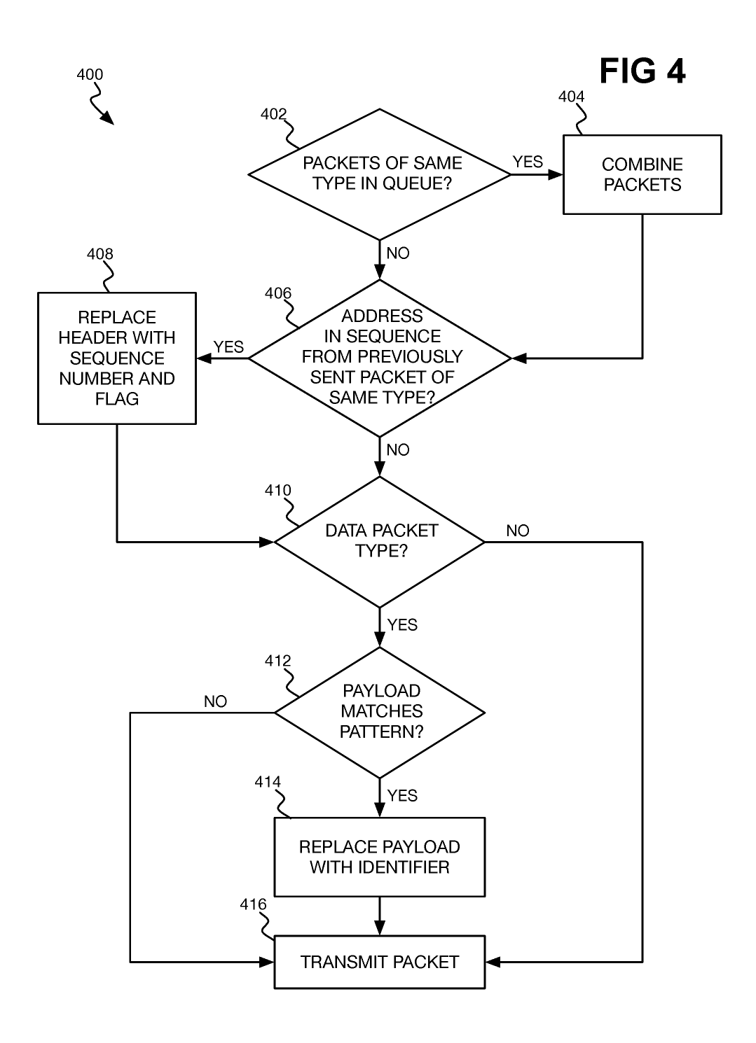

FIG. 4 shows an example method 400 that integrates the compression techniques of FIGS. 1, 2, and 3. A transmitting device can perform the method 400 to send a packet to a receiving device. A non-transitory computer-readable data storage medium may store program code that the transmitting device executes to perform the method 400.

If the transmitting device determines that a transmission queue includes packets of the same type and that refer to consecutive memory block addresses (402), then the device combines the packets within a single combined packet (404), as has been described in relation to the compression technique of FIG. 1. For instance, the length field of the combined packet can be set to span the length of all the packets within the queue. If the packets are of the data packet type or otherwise include payloads, then the payload of the combined packet can be set to include the payloads of all the packets within the queue.

If the transmitting device determines that the transmission queue does not include packets of the same type and that refer to consecutive memory block addresses (402), then the method 400 can proceed to part 406 with respect to a current packet to be transmitted, such as the first packet in the queue, where the method 400 is subsequently repeated with respect to the other queued packets. The method 400 also proceeds to part 406 from part 404, but where the single combined packet is considered as the current packet in relation to which part 406 is performed. In either case, if the transmitting device determines that the current packet is of the same type as and refers to a memory block address that is consecutive to the memory block address of the packet most recently sent from the transmitting device to the receiving device (406), then the method 400 can proceed to part 408. Specifically, the transmitting device replaces the header of the current packet with a sequence number and a flag indicating that the header has been replaced (408), as has been described in relation to the compression technique of FIG. 2.

After the transmitting device replaces the header of the current packet in part 408, or if the transmitting device determines that the current packet is not of the same type as and/or does not refer to a memory block address that is consecutive to the memory block address of the packet most recently sent to the receiving device (406), then the method 400 can proceed to part 410. Specifically, if the transmitting device determines that the current packet is of the data packet type (410) and thus includes a payload, and if the transmitting device determines that the payload matches a pattern within a compression dictionary (412), then the transmitting device replaces the payload with an identifier to which the pattern is mapped within the dictionary (414). That is, the transmitting device performs the compression technique of FIG. 3. More generally, in part 414 the transmitting device compresses the payload of the current packet.

After the transmitting device compresses the payload of the current packet in part 414, if the current packet is not of the data packet type (410), or if the current packet is of the data packet type but its payload does not match a pattern within the compression dictionary (414), then the method 400 can proceed to part 416. Specifically, the transmitting device transmits the current packet to the receiving device (416). If more than one packet is within the transmission queue, and the packets are not combined within a single combined packet, then the transmitting device may repeat the method 400 with respect to each packet within the queue, so that each packet is transmitted.

In performing the method 400, the transmitting device may have generated the current packet by performing the compression techniques of FIGS. 1, 2, and/or 3. The method 400 integrates all three of these compression techniques. However, in other implementations any two of the techniques may be integrated, or one of the three techniques may be employed by itself.

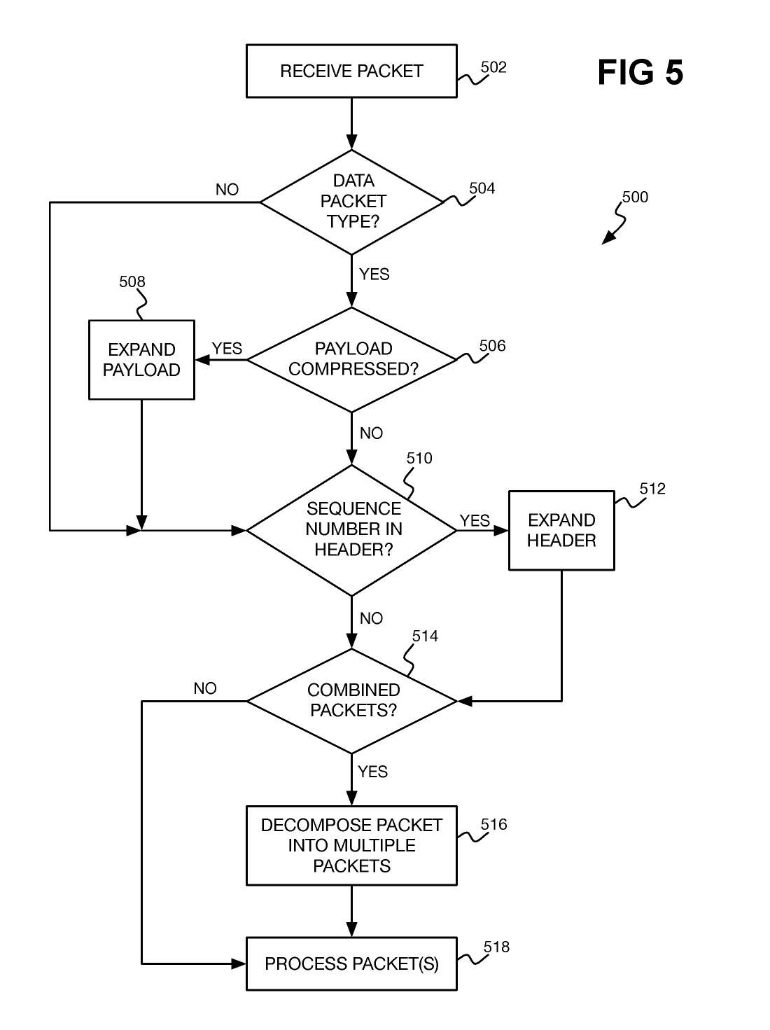

FIG. 5 shows an example method 500 that the receiving device performs after the transmitting device has transmitted a packet to the receiving device, such as in accordance with the method 400. A non-transitory computer-readable may store program code that the receiving device executes to perform the method 500. The receiving device thus receives a packet from the transmitting device (502).

If the receiving device determines that the received packet is of the data packet type (504), and if the receiving device determines that the packet's payload has been compressed (506), then the receiving device expands, or decompresses, the payload (508). The receiving device may determine whether the payload of the packet is compressed in part 506 by inspecting the packet's header for a flag that the transmitting device has added to indicate that the payload has been compressed. The receiving device may decompress the payload in part 508 by looking up a unique identifier of the payload within a compression dictionary that maps identifiers to patterns, and replacing the identifier within the packet's payload with the pattern to which the identifier is mapped, as in FIG. 3.

After expanding the packet's payload in part 508, if the packet is not of the data packet type (504), or if the packet is of the data packet type but does not have its payload compressed (506), the method 500 can proceed to part 510. Specifically, if the receiving device determines whether the packet has a sequence number in its header (510), such that the header is of reduced size, then the receiving device expands the header (512). The receiving device can make the determination of part 510 by inspecting the header for a flag that indicates the header is of reduced size. The receiving device can expand the header in part 512 by replacing the flag and the sequence number with a memory block address, length, and any other information, as in FIG. 2.

After expanding the packet's header in part 512, or if the packet does not have a reduced-size header (510), the method can proceed to part 514. Specifically, if the receiving device determines that the packet is a combined packet (514), then the receiving device may decompose or divide the packet into multiple packets (516), as in FIG. 1. After decomposing the packet into multiple packets in part 516, or if the packet is not a combined packet (514), the receiving device can process the packet(s) (518). If the received packet is a combined packet and has been divided by the receiving device into multiple packets, then these multiple packets are processed in part 518. If the received packet is not a combined packet, then this one received packet is processed in part 518.

Processing a packet in part 518 can include, for instance, performing an instruction on the data within the packet's payload in accordance with program code that the receiving device is executing, in the case where the packet is of the data packet type. By comparison, if the packet is of the data request type, then processing the packet in part 518 can include returning data back to the transmitting device in a reply packet of the data packet type. In this case, the receiving device becomes a transmitting device when sending the reply packet, and the transmitting device becomes a receiving device that receives this reply packet.

In the example method 500 of FIG. 5, the order in which decompression occurs is opposite to the order in which compression occurs in the example method 400 of FIG. 4. That is, the method 400 may first compress a packet according to the compression technique of FIG. 1, then compress the packet according to the compression technique of FIG. 2, and finally compress the packet according to the compression technique of FIG. 3. By comparison, the method 500 first decompresses the packet as may have been compressed in accordance with the technique of FIG. 3, then decompresses the packet as may have been compressed in accordance with the technique of FIG. 2, and finally decompresses the packet as may have been compressed in accordance with the technique of FIG. 1.

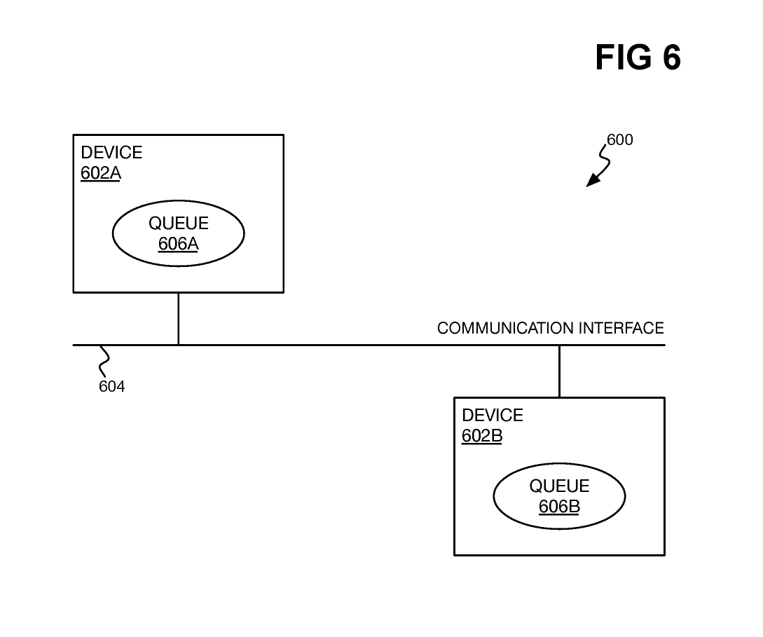

FIG. 6 shows an example system 600. The system 600 includes devices 602A and 602B, which are collectively referred to as the devices 602. While just two devices 602 are depicted in FIG. 6, there can be more than two devices. The devices 602 can be physically discrete processors, or different processor cores on the same physical die, memory, or other types of devices. The devices 602 are interconnected to one another over a communication interface 604. The device 602A includes a transmission queue 606A in which packets are queued for transmission. Likewise, the device 602B includes a transmission queue 606B in which packets are queued for transmission.

Each of the devices 602 can thus act as a transmitting device. For example, the device 602A may be a transmitting device when sending packets to the device 602B, in which case the device 602B acts as the corresponding receiving device. Similarly, the device 602B may be a transmitting device when sending packets to the device 602A, in which case the device 602A acts as the corresponding receiving device.

In some implementations, the same device 602A or 602B may act as both the transmitting device and the receiving device with respect to a packet. For instance, a first thread being executed on the device 602A may send a packet to a second thread being executed on the same device 602A. In this example, the device 602A is thus both the transmitting device and the receiving device.

Different techniques have been described for packet compression and decompression. Such compression and decompression techniques can be employed to increase communication rate and bandwidth. Similarly, such techniques can decrease the latency at which communication occurs.

We claim:

1. A packet compression method comprising:
determining, by a transmitting device, whether a plurality of packets within a transmission queue are of a same type as and refer to consecutive memory block addresses;
in response to determining that the packets within the transmission queue are of the same type as and refer to the consecutive memory block addresses:
combining, by the transmitting device, the packets within a single combined packet; and
sending, by the transmitting device, the single combined packet to a receiving device.

2. The packet compression method of claim 1, further comprising, in response to determining that the packets within the transmission queue are one or more of not of the same type as and do not refer to the consecutive memory block addresses:
sending, by the transmitting device, each packet to the receiving device.

3. The packet compression method of claim 1, wherein combining the packets within a single combined packet comprises:
setting a length field of a header of the single combined packet to span a length of all the packets.

4. The packet compression method of claim 3, wherein combining the packets within a single combined packet further comprises:
in response to the same type of the packets being a data packet type, setting a payload of the singled combined packet to payloads of the packets.

5. The packet compression method of claim 1, further comprising, in response to determining that the packets within the transmission queue are one or more of not of the same type as and do not refer to the consecutive memory block address:
determining, by the transmitting device, whether a current packet within the transmission queue is of a same type as and refers to a memory block address that is consecutive to a memory block address of a packet most recently transmitted to the receiving device;
in response to determining that the current packet is of the same type as and refers to the memory block address that is consecutive to a memory block address of the packet most recently transmitted to the receiving device:
replacing, by the transmitting device, a header of the current packet with a reduced-size header including a sequence number and a flag indicating the header has been replaced with the reduced-size header; and
sending, by the transmitting device, the current packet having the header replaced by the reduced-sized header to the receiving device.

6. The packet compression method of claim 5, wherein the sequence number indicates a number of the current packet within a sequence of packets, including the current packet and the packet most recently transmitted, which refer to consecutive memory block addresses.

7. The packet compression method of claim 5, further comprising, in response to determining that the current packet is one or more of not of the same type as and does not refer to the memory block address that is consecutive to the memory block address of the packet most recently transmitted to the receiving device:
determining, by the transmitting device, whether the current packet is of a data packet type;
in response to determining that the current packet is of the data packet type, compressing, by the transmitting device, a payload of the current packet; and
sending, by the transmitting device, the current packet with the compressed payload to the receiving device.

8. The packet compression method of claim 5, further comprising, in response to determining that the current packet is of the same type as and does refer to the memory block address that is consecutive to the memory block address of the packet most recently transmitted to the receiving device:
determining, by the transmitting device, whether the current packet is of a data packet type;
in response to determining that the current packet is of the data packet type, compressing, by the transmitting device, a payload of the current packet.

9. The packet compression method of claim 8, wherein compressing the payload of the current packet comprises:
determining that the payload matches a pattern within a compression dictionary; and
replacing the pattern within the payload with an identifier to which the pattern is mapped within the compression dictionary.

10. The packet compression method of claim 1, further comprising, in response to determining that the packets within the transmission queue are of the same type as and refer to the consecutive memory block address:
determining, by the transmitting device, whether single combined packet is of a same type as and refers to a memory block address that is consecutive to a memory block address of a packet most recently transmitted to the receiving device;
in response to determining that the singled combined packet is of the same type as and refers to the memory block address that is consecutive to a memory block address of the packet most recently transmitted to the receiving device:
replacing, by the transmitting device, a header of the single combined packet with a reduced-size header including a sequence number and a flag indicating the header has been replaced with the reduced-size header.

11. The packet compression method of claim 10, wherein the sequence number indicates a number of the current packet within a sequence of packets, including the single combined packet and the packet most recently transmitted, which refer to consecutive memory block addresses.

12. The packet compression method of claim 10, further comprising, in response to determining that the packets within the transmission queue are of the same type as and refer to the consecutive memory block address:
determining, by the transmitting device, whether the single combined packet is of a data packet type; and
in response to determining that the single combined packet is of the data packet type, compressing, by the transmitting device, a payload of the single combined packet.

13. The packet compression method of claim 11, wherein compressing the payload of the current packet comprises:
determining that the payload matches a pattern within a compression dictionary; and
replacing the pattern within the payload with an identifier to which the pattern is mapped within the compression dictionary.

14. A packet decompression method comprising:
receiving, by a receiving device, a packet from a transmitting device;
determining, by the receiving device, whether the received packet is a combined packet into which a plurality of packets referencing consecutive memory block addresses have been combined by the transmitting device;
in response to determining that the received packet is the combined packet:
decomposing, by the receiving device, the received packet into the plurality of packets referencing the consecutive memory block addresses; and
processing, by the receiving device, each packet of the plurality of packets.

15. The packet decompression method of claim 14, further comprising, in response to determining that the received packet is not the combined packet:
processing, by the receiving device, the received packet.

16. The packet decompression method of claim 14, further comprising:
determining, by the receiving device, whether a header of the received packet is a reduced-size header in which an original header of the received packet was replaced with the reduced-sized header including a sequence number and a flag indicating that the original header has been replaced with the reduced-size header; and
in response to determining that the header is the reduced-sized header:
expanding, by the receiving device, the reduced-sized header back to the original header.

17. The packet decompression method of claim 14, further comprising:
determining by the receiving device, whether the received packet is of a data packet type;
in response to determining that the received packet is of the data packet type:
determining, by the receiving device, whether a payload of the received packet has been compressed; and
in response to determining that the payload of the received packet has been compressed:
decompressing, by the receiving device, the payload of the received packet.

18. A system comprising:
a transmitting device to:
compress a current packet that is of a same type as and refers to a memory block address that is consecutive to a memory block address of a most recently transmitted packet, by replacing a header of the current packet with a reduced-sized header including a sequence number and a flag indicating the header has been replaced with the reduced-size header;
transmit the current packet; and
a receiving device to:
receive the current packet that the transmitting processer transmitted;
decompress by the current packet by removing the flag from the reduced-size header and by replacing the sequence number with a memory block address equal to the memory block address of the most recently transmitted packet and an offset based on the sequence number.

19. The system of claim 18, wherein the transmitting device is further to combine a plurality of packets within a transmission queue of the same type and that refer to consecutive memory block addresses within a single combined packet, as the current packet,
and wherein the receiving device is further to decompose the single combined packet back into the plurality of packets.

20. The system of claim 18, wherein the transmitting device is further to replacing a pattern within a payload of the current packet with an identifier to which the pattern is mapped within a compression dictionary,
wherein the receiving device is further to replace the identifier within the current packet with the pattern to which the identifier is mapped within the compression dictionary.
